(19) United States
(12) Patent Application Publication
(10) Pub. No.: US 2013/0080776 A1
(43) Pub. Date: Mar. 28, 2013

(54) Secure Document Collaboration

(71) Applicant: John T. Elduff, West Chester, PA (US)

(72) Inventor: John T. Elduff, West Chester, PA (US)

(21) Appl. No.: 13/247,821

(22) Filed: Sep. 28, 2011

(51) Int. Cl. H04L 9/32; G06F 17/00

(52) U.S. Cl. 713/168

(57) ABSTRACT

The present invention provides a secure method for a trusted group of users, researchers and/or collaborators to share, comment, enter into an electronic chat about, and/or make revisions to electronic information/documents while maintaining confidentiality of the material and fostering a related collaborative discussions and forum. The invention creates a dynamic work share environment where the ideas that are exchanged are protected from unwelcomed and uninvited participants. Disclosed is a method and system for secure, multi-user document discussions and/or document collaboration through a cellular/mobile network or the Internet particularly through a computer application or smart phone that may occur in real-time.

### FIELD OF THE INVENTION

The invention relates generally to the field of document discussion and/or collaboration, and in particular to a method and system for document collaboration over a communications network. Particularly, this invention relates to a method and system for enabling secure discussions and/or document collaboration that provides multi-user environments over computer networks such as cellular/mobile technology or the Internet. More specifically is disclosed a method and system that allows users to interact, debate, discuss and collaborate over ideas, concerns and documents using a computer application designed for a personal data device such as an I-PHONE/smart phone, I-PAD/smart book/tablet and HTML in a secure and potentially real-time environment. To promote freedom in the exchange of ideas, the discussion content is restricted and accessible only to a selected member group decided by the discussion creator.

### BACKGROUND OF THE INVENTION

It has been long known that creative collaboration in the scientific, legal, engineering and business communities promote successful and progressive research and ultimately new and unique discoveries that aide the broader good of science, technology and business for human kind. It is also well known, that while scientists, engineers, lawyers and business people share this primary goal they must also balance this goal with the demands of intellectual property protection, privacy, security, funding and multi-governmental regulation. Typical methods that each employ to share and use ideas and research has been linear, unprotected, arcane and cumbersome at best. Previously, scientists, lawyers, engineers and business leaders used basic word processing applications, with traditional editing tools like the redline application, to collaborate on documents and then send the documents by unsecure e-mail. The ever changing digital and electronic media environment has rapidly, fundamentally, and irreversibly changed research collaboration efforts to contemporary requirements that are hi-tech, dynamic, potentially real-time, provide access to multiple but restricted users while providing a confidential forum to access documents and collaborate on emerging ideas. These methods are now outdated and risky due to the increasingly sinister efforts of global information pirates and hackers. Since these older methods have proven to be risky and with a highly limited user interface, a new platform for data collaboration and a scientific exchange of ideas is crucial to advance science and promote commerce.

E-mail and a growing range of other network technologies efficiently and rapidly link researchers from around the globe and enhance informal communication however, they do not provide a potentially real-time, secure application for researchers to collaborate on specific programs. One solution to enhance scientific, engineering, legal and business on-line collaborative efforts has been to form and manage specific interest groups within the social media community. The drawback is that, while social media and specific interest groups offer the ability to reach a wide audience, they do so with out the security of anti-spam or malware protection solutions or a secure collaboration environment.

Another method for on-line collaboration is through electronic bulletin board forums. These forums may be private, accessible to members only, or may be open, accessible to Internet users in general to read, though they must join in order to post messages. However, whether they are open or closed forums, every discussion within the forum are generally unsecure and available to all forum members. This present a problem when a member wants to share the discussion only with a selected subset of members due to the sensitive nature of the topic. A discussion originating member does not have a mean of limiting membership for the discussion within this type collaborative forum.

Another alternative is to use a private mailing list that would only send messages to a selected group of recipients. While this solves the problem of membership restriction, it has a number of deficiencies that merit a more dedicated system. In an email system, having discussion on a lengthy published or pre-published source with many passages in question is cumbersome and potentially confusing. In general, emails do not have a dedicated method of referring to selected passages in an external source article. Typically, email users would duplicate the passage of interest and append additional comments and responses. This act takes the passage of interest out of its context as well as decouples it from the external source. While it may be manageable on a small scale, this system would be difficult to maintain for discussions on a lengthy article or across a number of articles within some research subject.

Also, the security of an email system is difficult to enforce. Encryption is not generally available on major email applications. It typically requires either, a plug-in program extension such as ENIGMAIL for THUNDERBIRD, a FIREFOX email client, or a dedicated secure email gateway. Each discussion participant would also require some knowledge in managing encryption keys. Even with the encryption tools available, the user must remember to encrypt the messages within the discussion group. Also, the security provided by encrypted messages does not protect the security of the discussion group when each participating users have ability to add other users to the recipient lists and the ease to forward the discussion message to non-members within an email environment. These potential security issues may create a level of uncertainty that limits the freedom for discussion sharing.

Further, these collaborative methods can not access secure a document from a secure server, highlight a portion of document, annotate the document, publish the document to the secure server, choose a secure group to further annotate the document and then enable the members of the group to continue annotation on the specific topic or the greater of the document.

Other collaborative groups are merely interest groups that a user can join to publish their work, review published articles of another to post open question for discussion. These environments are not dynamic or potentially real-time. In prior art systems, the user is the maintains the information and there does not exists a method and system for enabling the collaboration of documents through a secure document server that: maintains and uploads the documents to be discussed; maintain the list of approved users; enable the access to the documents; maintains the users, stores secure discussions, and provides selective membership to the discussion by the discussion leader.

In any area of medical research, engineering, law or business, if an open an honest discussion about sensitive topics are to be held then it is a requirement that collaborators must be able to discuss opinions, topics, findings or the like in a secure environment where the concern of repercussions are negated. Most scientific, legal and design literature is now created in digital form and, in nearly every discipline; some scholarship is digital-only or can be fully understood only in digital form. Researchers have used the Internet to rapidly form new or ad hoc communities of scientists, developers and lawyers in response to any crises to discuss these documents and such contemporary issues as cancer, severe acute respiratory syndrome and avian influenza. Scientists, lawyers, engineers and business leaders using the interconnectivity of the Web have begun to break down information silos, allowing interdisciplinary perspectives on complex questions and vexing challenges, and teams of investigators in far-flung time zones work together effectively and easily, quickly sharing information. However, the fear that their open discussion may become public and then later used against them prevents the existence of many important discussions.

Medical and other types of journals have been comparatively slow to embrace the potential of the ubiquitous network. True, online editions are now the norm for most journals and online reference linking has made it easier to navigate the literature. But fundamentally, most online journals are simply digital editions of their print analogs. Scientists and organizations, often contemplate what journals could eventually become by seeking not only intellectual property development, but also a forum to publish works for the advancement of science, law, technology and business. Based upon the foregoing it is evident that a need exists to enable research journals and researchers alike a method for real-time, iterative, collaborative refinement of scientists' understanding of research while maintaining an environment where the electronic document collaboration is secure and confidential. Therefore, there exists a need for a dynamic, real-time method and system for securely maintaining electronic document and information and enabling protected confidential forum to discuss and comment and revise documents where the secure server manages the collaboration process including access to the documents, group approved users and secure discussions.

### SUMMARY OF THE INVENTION

The present invention provides a system and method, for potentially real-time document discussion and/or collaboration between users using a secure document system and one or more contributing users. This new invention allows scientists, researchers and collaborators to confidentially share ideas and knowledge without the risk that their work will be usurped. The originating user will define the membership set of participating users at the start of a discussion or a thread of discussion.

In one embodiment, membership to a select discussion group is for entire article. A registered user creates a discussion for an article with a group of other users. Each participating user will have access to the discussion to read existing comments and to create new comments.

In a second embodiment, membership to a select discussion group is based upon individual sections within an article. This allows a single user to manage multiple discussions with different user memberships. The originating user will select a passage to create a discussion thread and define the membership for that thread. Each new discussion thread will have its set of members. A user will have access and only see annotated sections in an article for which he or she has membership. This is a finer grain control at the section by section level.

In one embodiment, a user accesses the secure application, selects an original document from the secure document system. The user identifies an area of the document to start discussions or to modify and then annotates the document accordingly and then publishes the annotations to the secure system. The user may select another group of users from the secure system that may then access the annotations. Thereafter the selected users may access or be sent links to the secure document and the new user may further annotate the document. A user may choose to now continue the thread of annotations or start a new annotation based upon a new area of text or a previous annotation this new annotation may be with the previous group or a new secure group may be selected by the new user. Discussions and collaboration are conducted in real-time and are secure. In another embodiment, the user may first post the document to the secure server for verification of authenticity and then begin the secure annotation process.

The present invention may be a computer application used over a hardwired, cellular/mobile network to allow collaborative research and review of articles published on their printed and electronic media. The application provides secure access where the user may restrict viewing to a selective group of users in a secure encrypted environment utilizing duel encryption on the device as well as on the server.

Collaboration is in the form of annotations, which may include comments about and/or revisions of the articles. The comments and/or revisions may include audio, video, graphics, as well as written text. The user publishes the information through an encrypted server database as well as on the mobile unit (duel encryption) and distributes the information to and only to the intended trusted source recipients. The user creates an ad-hoc discussion group by sending invitations to selected members from the user's list of contacts. The individual that initiates the annotation on a given article may able to add and delete recipients as needed to protect the integrity of the discussion. To maintain security and freshness of information, the application may implement a time limit to the storage of published comments on the local mobile device. The application would delete all published comments within a discussion if the last update from the remote server has exceeded the time limit. Once the user connects with the remote server, the discussion will refresh with the latest information and the application will reset the time period. In the case of a deleted recipient from the group, the application may also remove the entire discussion from the deleted individuals local device storage.

### BRIEF DESCRIPTION OF THE DRAWINGS

FIG. 1 is a block diagram of one example of a system in which the present invention may reside.

FIG. 2 illustrates one embodiment of the operational flow diagram illustrating a process for secure document discussion and collaboration in accordance with the present invention.

FIG. 2a is a continuation of one embodiment of the operational flow diagram illustrating a process for secure document discussion and collaboration in accordance with the present invention of FIG. 2.

FIG. 2b is a further continuation of one embodiment of the operational flow diagram illustrating a process for secure document discussion and collaboration in accordance with the present invention of FIG. 2a.

FIG. 2c is a further continuation of one embodiment of the operational flow diagram illustrating a process for secure document discussion and collaboration in accordance with the present invention of FIG. 2b.

FIG. 3 illustrates another embodiment of the operational flow diagram illustrating a process for secure document discussion and collaboration in accordance with the present invention.

FIG. 3a is a further continuation of one embodiment of the operational flow diagram illustrating a process for secure document discussion and collaboration in accordance with the present invention of FIG. 3.

### DETAILED DESCRIPTION OF THE INVENTION

The present invention provides a secure method for researchers and collaborators to share, comment on, and make revisions to electronic information and yet also maintain the confidentiality of the documents and the collaborative forum. The invention creates a work share environment where the ideas that are exchanged are protected from unwelcomed and uninvited participants.

In one embodiment the invention takes advantage of such application centric products, and personal data communication devices such as for example, the I-PAD and I-PHONE or other smart phone devices. The user retrieves a source material such as a journal article for review from the remote database server and store in the local device (such as the I-PAD) database. The source material is available from a common server. A common server is defined as a server that serves the same source materials to all participating users. It may be a single server unit or a set of separate servers. The material may be purchased, available through a subscription, or free.

To begin a discussion on any section of interest, in one embodiment, the user creates a discussion group entity on a remote server for the source article. The user will define a list of allowed members to participate in the discussion. The user will also specify an encryption key for the discussion. The server will send an invitation to the discussion to each member on the list. The invited members will then able to access the discussion group entity from the remote server to retrieve all content associated with that discussion. Once the membership list is defined, the user may select a specific text sequence or location in the article to create a new annotation by highlighting the words or line or merely pointing to the area that is in discussion or that the user intends to discuss. All subsequent annotations and comments from the participating members are collected under this discussion group. The content of the discussion group is available to all the participating members.

In a second embodiment, to begin a discussion, the user selects a specific text sequence or location in the article and creates a new annotation. The user then defines membership access from a list for the annotation. Here the user can restrict or enable access to the present collaboration. The remote server will manage the distribution of the discussion thread to the valid participating members. This process provides different threads of discussions within the same article where the collaborative membership for each discussion thread may be different. This allows a number of separate discussions with different members to occur at the same time within a single article. From the user's point of view, the user will only see annotated sections in which the user is a participating member.

In either embodiment, the discussion originating user is in control of the membership access to the particular discussion. The user may restrict access to the discussion using a list that is already present on the server. The list is retrieved from the remote server for the specific user and then the list entries are administered through the remote server web portal. The user then publishes the annotations for an article to the remote server. Here the user identification is verified against server registration database, annotations are encrypted with secure key prior to sending to the remote server and the server stores encrypted annotation in database in the encrypted form. The server does not keep any copy of the secure keys, thus, the security of the data is maintained should any attempts are made to access the discussion at the remote server.

Thereafter, another user may retrieve all annotations for an article in which she or he has member access. Again, user identification is verified against server registration database for valid discussion membership. Once the encrypted information is retrieved from the server, the system will decrypt the information for presentation using the pass key that is defined by the discussion originating user and is communicated amongst the collaborating members outside of the present system. Each thread including a comment or annotation may be accessed multiple times by multiple users and commented or modified securely in real-time over the smart phone application. Each thread has many comments and every annotation or comment can be individually and specifically accessed and further annotated or discussed by a selected set of users or the entire group. The discussion thread history is maintained by the secure server. The originator of the discussion may maintain control of the discussion group participants, thus, protecting the information that is being exchanged.

This method and system allows users of or a web based journal to read and discuss articles from the journal also allows users to share, annotate, and discuss articles through an encrypted server with a selected group of people, which guarantees the confidentiality of discussion. This feature allows researchers from around the world to review and discuss a given article in real time with a selected group of trusted peers and within a secure forum, protected from the expanse of the greater Web community. This is not only important from a confidentiality and privacy perspective, but it also enables the participants to exchange in a free collaboration of ideas, regardless of their merit or scientific validity. Therefore, even bad or untenable ideas can be flushed out without the fear of embarrassment or professional criticism. This level of security and privacy will better promote the free exchange of ideas and concepts.

The shared information is encrypted with industry accepted secure protocol such as Advance Encryption Standard (AES) algorithm at 192 bits which ensures that all shared information remains fully secure. This encryption system allows for a secure environment in which users from around the world can share thoughts and feedback without sacrificing the integrity of the discussion.

This method and system is of particular use to pharmaceutical companies performing post publication literature reviews to ensure accuracy, and adherence to FDA approved usage.

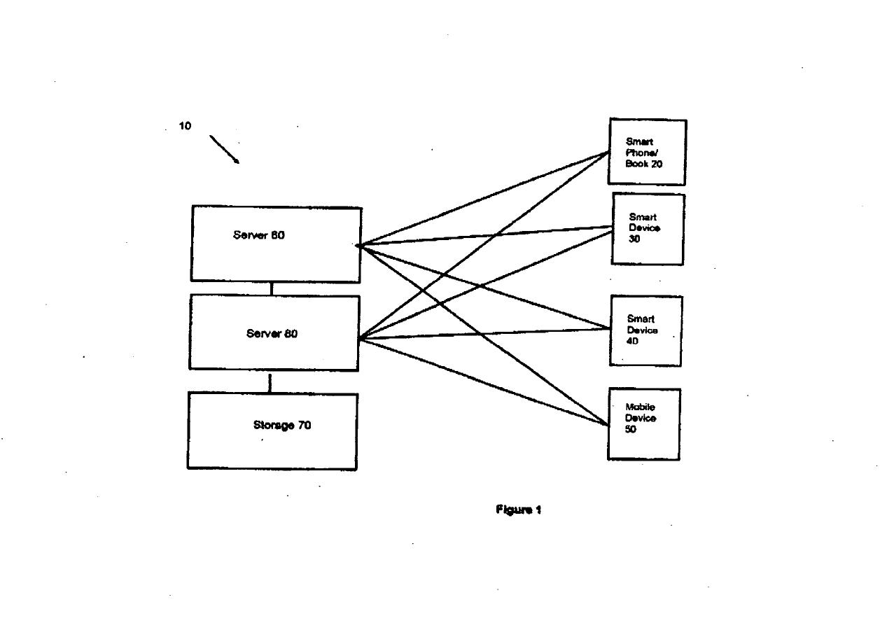

Now turning to FIG. 1 there is disclosed a block diagram 10 of the system in which the present invention may reside. In one embodiment user accesses and is authenticated at server 60 and user retrieves documents at server 80 through a smart phone or smart book 20. Server 60 verifies discussion membership and maintains access to the secure encrypted discussions stored at memory/disc 70. Additional smart devices 30 and 40 and other mobile devices 50 may also access the server 60 to engage in secure discussions or server 80 to retrieve secure documents.

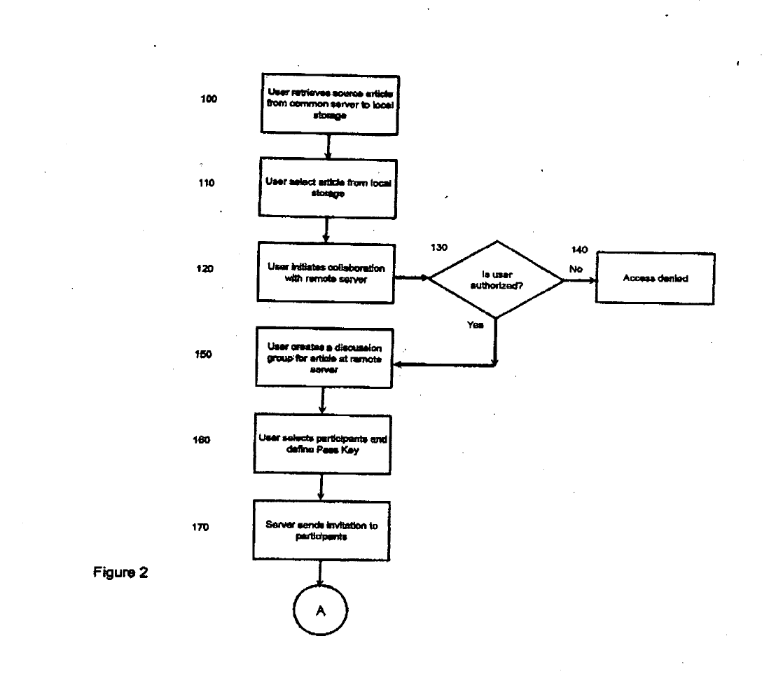

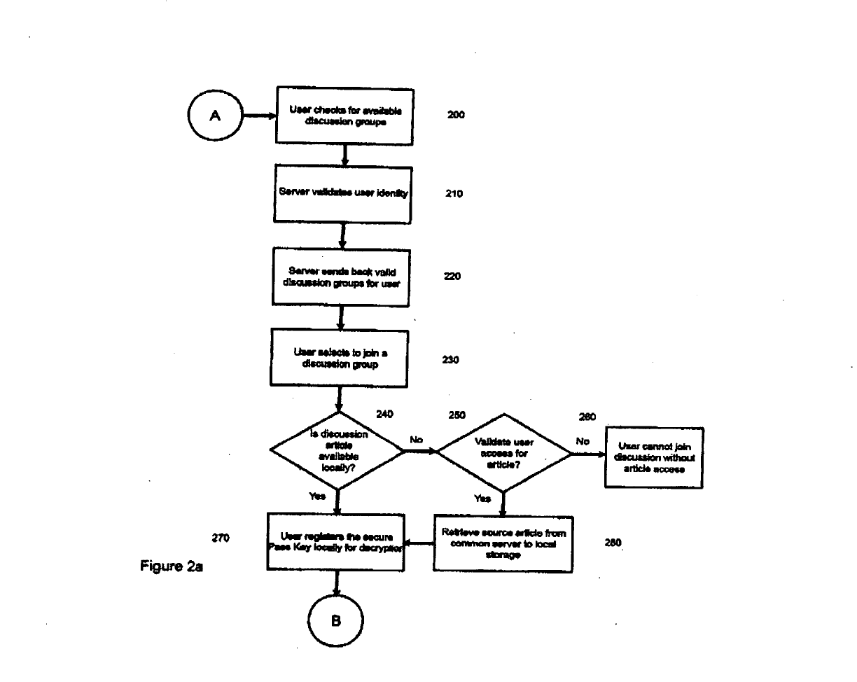

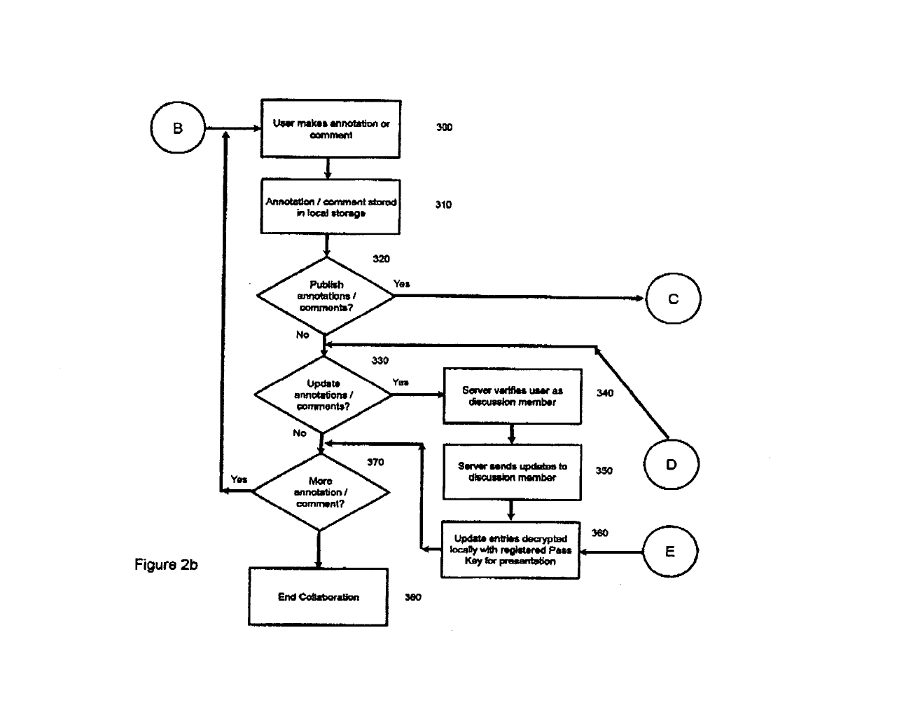

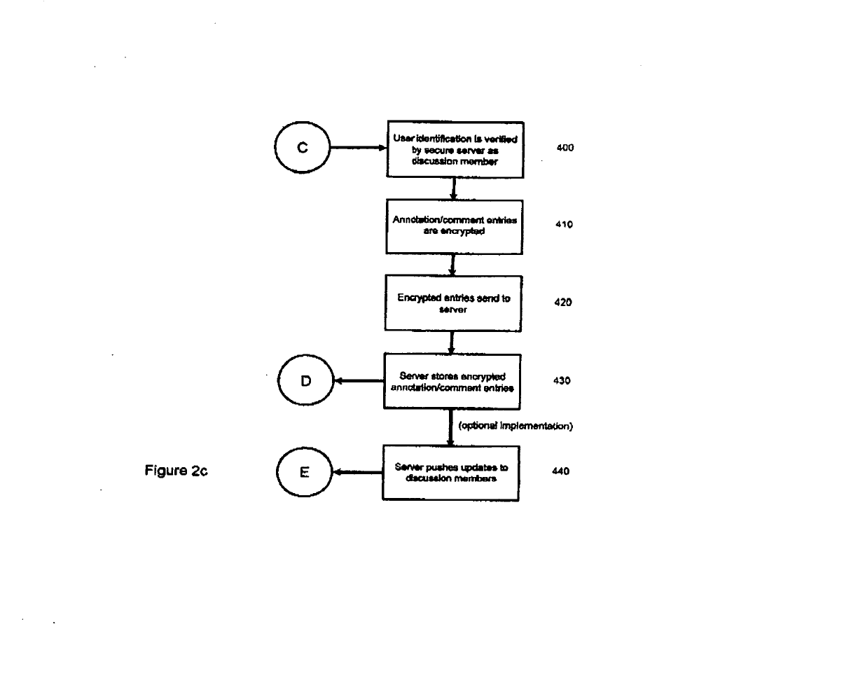

Now turning to FIG. 2, there is shown an operational flow diagram illustrating a process for secure document discussion and collaboration in accordance with the present invention. The system provides access to the source materials for discussion from some common server (shown collectively as server 80 in FIG. 1). This may be a single server or a set of server that provides the service. The source materials may be free, or available as direct purchase or as part of a subscription service. At step 100, the user retrieves source articles and saves them to the local device (such as the I-PAD) database for later review. From the list of articles, the user selects one for review at step 110. The user wishes to discuss some aspect of the article with a specific group of people and initiates the collaboration on the local device with the remote server, step 120. The remote server verifies the user's identity to allow access in creating a collaborative discussion group, step 130. If the remote server cannot verify the user's identity at step 140, the user is barred from initiating a discussion. Otherwise, the remote server, in step 150, will let the user create a discussion group entity by providing a discussion identifying name, defining a reference to the source article, selecting from a list of contacts for the group membership, and defining an encryption pass key, step 160. The pass key is actually not absolutely necessary but does provide an additional layer of security in the event the unit is lost or stolen. It is used in this implementation to provide an encrypted check value to conveniently test the validity of subsequently entered security pass keys. It also helps the user to establish the desired pass key with the discussion group at this point. The remote server does not store the actual pass keys. Once the discussion group is created, the remote server at step 170 will send an invitation to each user on the discussion group membership list to announce the new discussion group.

Proceeding to FIG. 2a, step 200, the method provides the option for the user to check whether the user is a participant in any discussion group. This may be prompted by the discussion invitation from step 170, or as just a routine check. In step 210, the remote server receives the request and validates the users identity. In step 220, the server sends back references to all discussion groups in which the user is a participating member. From the list of discussions, the user will select which one to be the active discussion in step 230. From this point onward in this embodiment, all annotations and comments will be associated with this discussion group entity until the user ends the collaboration and/or switches to a different discussion. The method will check if the source article for this discussion is available locally at step 240. If not, then the method verifies at step 250 whether the user has access to the article at the common server. Once the user is determined to have access to the article, then the source article is retrieved to the local database at step 280. With the discussion source article available locally, the method at step 270, will request the secure pass key for this discussion. This key is stored locally for the decryption process. At this point, the method may verify the pass key by decrypting the stored encryption check value that resulted from step 160. If this process fails to produce the known check value, then the user may be prompted to re-enter a valid pass key before allowed to join the discussion. Up to this point terminating at point B, the steps have provided the discussion setup process. The remote server maintains and administers the discussion entities and membership associated with each discussion. Only the originating user has access to any changes to the membership list.

Moving on from point B, FIG. 2b, the process of handling annotations and comments begin. Within a discussion, the user may create an annotation by highlighting the words or line or merely pointing to the area that is in discussion or that the user intends to discuss. Or, the user may select an existing annotation and proceed to respond with additional comments. Once the annotation or comment is created at step 300, the new entry is stored on the local device, step 310. The user may now have the choices to publish the yet unpublished entries, step 320, get an update of any new entries created by other discussion members, step 330, or create additional annotation or comment entries, step 370.

If the user chooses to publish the unpublished annotation and comment entries, then the method proceeds to point C as illustrated by FIG. 2c. The user's identity is verified by the remote server and determined to be a member of the discussion group, step 400. If this fails, then the remote server will return an error to the local device that the publish request will be ignored. Otherwise, the local device will begin the publish process by first encrypting all annotation and comment entries, step 410, then send the encrypted entries to the remote server at step 420. The remote server will store the encrypted entries in its storage database awaiting distribution to the discussion members. If the real-time update option is not implemented, then the method returns to FIG. 2b via point D where the distribution of the stored entries is initiated by a user's update request at step 330. However, with real-time option implemented, the remote server will push the updates at step 440 to discussion members who are currently on-line, actively participating in the discussion and able to receive the new annotation and comment entries. The local device receives the update messages from the remote server at step 360 and proceeds to decrypt the received discussion entries using the stored security pass key for that discussion group.

If the user chooses to request an update of annotation and comment entries for the current discussion, step 330, then the local device will send the user identification information to the remote server for verification in the discussion group membership, step 340. Once verified, the server sends back the encrypted updates to the currently active discussion, step 350. Again like the live updates, the local device receives the update messages from the remote server, step 360, and proceeds to decrypt the received discussion entries using the stored security pass key.

At step 370, the user may choose to continue adding more annotation or comments. This will re-start the sequence of steps from point B.

The method ends at step 380 when the user may choose to stop participating in the discussion until a later time.

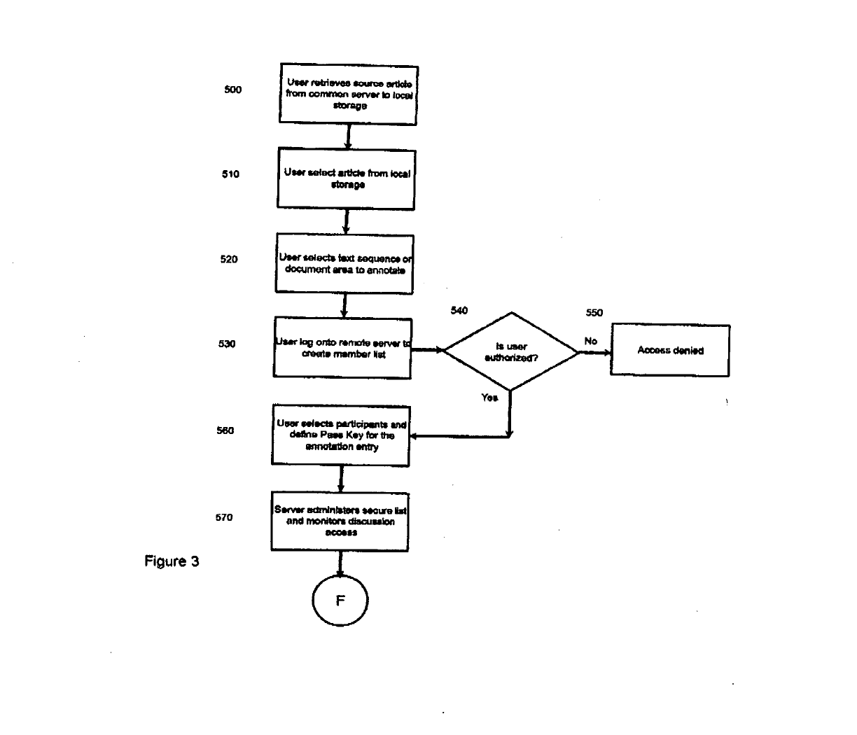

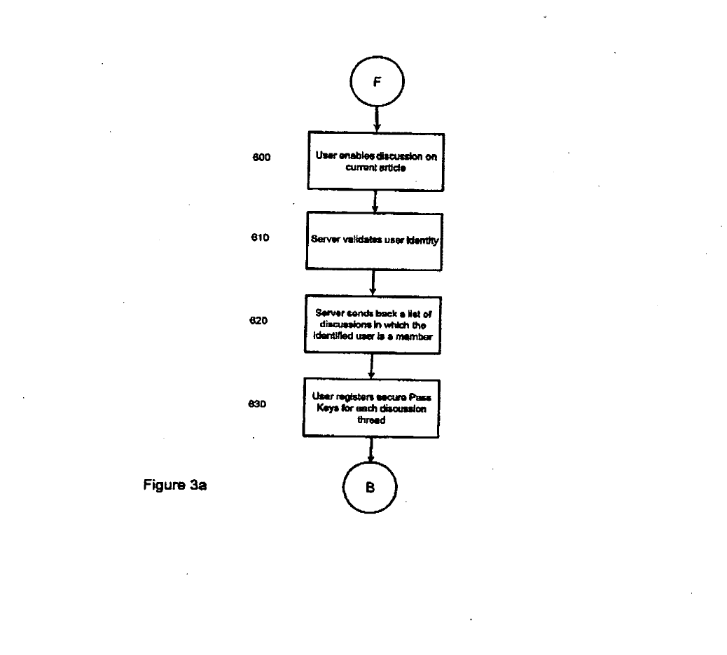

The discussion setup process as shown in FIG. 2 and FIG. 2a, up to point B represents one embodiment of the method. In another embodiment as shown in FIG. 3 the method begins the same way at step 500, 510 identical to step 100, 110 in the first embodiment where the user retrieves the desired source article for discussion on the local device. At step 520, the discussion initiation process diverges. The user creates an annotation first by selecting a text sequence or document area on the source article for discussion. At step 530, the local device provides access to the remote server to create a member list for the selected annotation. The local device sends the user identity to the remote server at step 540 for verification and authorization. If the user does not have the authority to create discussions, then the user is denied access at step 550. If however, the user has the authority to create discussions, then the user moves to step 560 and will use the local device to interact with the remote server to select the list of participants and define the encryption pass key for the selected annotation entry. Hereafter, at step 570, the remote server will administer the membership list and manage the allowed user access to the discussion for the annotation entry.

FIG. 3a, shows the process to access the annotation entry discussions under this embodiment. The user in step 600 enables all discussions on the current source article. The local device sends the user identity to the remote server for validation on step 610. Once the remote server identifies the user, the server at step 620 sends back a list of discussions in which the identified user is listed as a member. The user registers the encryption pass keys for each of the discussion thread to gain access. The user may have the option of enabling selected discussion threads of interest. Instead of a single discussion group that is active as in the first embodiment, this process provides multiple active discussions within the same article where the collaborative membership for each discussion thread may be different. This allows a number of separate dikussions with different members to occur at the same time within a single article. From the user's point of view, the user will only see annotated sections in which the user is a participating member.

After the discussion initiation process at step 630, the method progress back to point B on FIG. 2b. The difference is instead of a single discussion group, the local device and the remote server are handling annotations and comments for multiple discussions at the same time.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claims is:

1. A method, for secure document discussion and collaboration using a secure communication network the method comprising the steps:
Logging on to the secure server;
verifying access to the server;
accesses a document from the server;
retrieving a secure document from the secure server;
storing the document in a local device;
selecting a specific text sequence or location in the document;
creating an annotation;
defining membership access from a list maintained at the server;
publishing the annotations to the remote server;
encrypting the annotations with secure key; and
storing the encrypted annotations at the secure server and local device.

2. The method of claim 1, further comprising:
verifying access to the secure server; and
retrieving document annotations from a secure server.

3. The method of claim 2, further comprising:
decrypted the annotations

4. The method of claim 3, further comprising:
further annotating the document.

5. The method of claim 3, further comprising:
creating a new annotation based upon the specific text sequence or location in the document

6. The method of claim 1, further comprising:
maintaining a record of the annotations stored at the secure server.

7. The method of claim 1, further comprising:
notifying users of a published annotation.

8. A method, for enabling secure document discussion and collaboration using a secure communication network the method comprising the steps:
logging on to the secure server,
verifying access to the server;
selecting a group from a list maintained at the server;
identifying a document from the server;
retrieving a secure document from the secure server;
creating an annotation;
publishing the annotations to the remote server;
encrypting the annotations with secure key; and
Storing the encrypted annotations at the secure server as well as the local device with an additional encryption for added security.

9. The method of claim 8, further comprising:
verifying group access to the secure server; and
retrieving document annotations from a secure server.

10. The method of claim 8, further comprising:
decrypting an annotation.

11. The method of claim 8, further comprising:
making further annotations to the document.

12. The method of claim 8, further comprising:
creating a new annotation based upon a new text sequence or location in the document.

13. The method of claim 8, further comprising:
maintaining a record of the annotations stored at the secure server.

14. The method of claim 8, further comprising:
notifying select group of a published annotation.
